(19) United States
(12) Patent Application Publication
(10) Pub. No.: US 2022/0316160 A1
(43) Pub. Date: Oct. 6, 2022

(54) SINGLE ENGINE SWEEPER SYSTEM WITH IMPROVED PUMP MOUNTING MECHANISM

(71) Applicant: Roots Multiclean Inc., Huntsville, AL (US)

(72) Inventors: Ramasamy KRISHNASWAMY, COIMBATORE (IN); Steve HANVEY, Huntsville, AL (US)

(21) Appl. No.: 17/363,602

(22) Filed: Jun. 30, 2021

(30) Foreign Application Priority Data
Apr. 5, 2021 (IN) 202141015969

(51) Int. Cl. E01H 1/08; B60K 25/02

(52) U.S. Cl. CPC E01H 1/0845; B60K 25/02; B60K 2025/026

(57) ABSTRACT

The invention proposes a single-engine, truck-mounted sweeper machine that incorporates systems and devices for an improved power pack mounting mechanism. A propeller shaft mounted at the side of the engine is used to take power from a driven pulley. At the rear end of the propeller shaft a suitable capacity power pack driving the sweeping system is attached. A clutch is introduced between the engine-driven pulley and the power pack, which may be coupled or decoupled as required instead of driving the power pack all the time. The power pack may be activated or deactivated for better component life and to conserve energy. In place of hydraulic pump an electric generator may be substituted. The overall advantage of the invention is that higher power could be provided for effective sweeping function in truck-mounted sweepers, without change in engine capacity or environmental concerns such as emissions.

### CROSS-REFERENCES TO RELATED APPLICATIONS

This application claims priority to Indian patent application No. 202141015969 entitled “SINGLE ENGINE SWEEPER SYSTEM WITH IMPROVED PUMP MOUNTING MECHANISM” filed on Apr. 5, 2021, the full disclosure of which is incorporated herein by reference.

### FIELD OF THE INVENTION

The disclosure relates generally to sweeping machines and in particular to improved hydraulic pump mounting arrangements therefor

### DESCRIPTION OF THE RELATED ART

Parking-lot sweepers and street sweepers are essential systems to clean large parking lots and roads. Regenerative vacuum sweepers are used to collect debris by using the suction force developed by the fan. A sweeper system as illustrated in FIG. 1, is mounted on a truck 1, typically having four wheels. The sweeper consists of regenerative suction and air flow created by the rotation of a fan present inside a fan housing 4, a pick-up head 2 to collect the debris through a regenerative airflow system which conveys the debris into a hopper 3. A screen present inside the hopper filters the debris inside it and allows the air to flow back through the system. Gutter brooms 6 mounted on each side of the sweeper, are used to sweep and throw the debris present on the sides of the vehicle into the pick-up head which is then sucked and conveyed into the hopper.

These Sweepers are classified in to two categories, dual engine and single engine sweepers. A. Dual engine sweepers: In dual engine sweepers, there will be an Auxiliary engine to drive one or more hydraulic pumps to power all sweeper functions in addition to the engine that comes with the chassis for vehicle propulsion. Disadvantage of the dual engine systems are: Both the engines would be running during sweeping resulting in high fuel consumption, excessive noise and high maintenance cost. It would be prohibitively expensive to meet the current emission norms.

B. Single engine sweepers: During sweeping operation, the power required for the vehicle propulsion is very minimal. Hence the excess power available with the truck engine is used to drive the hydraulic pump to power the sweeper functions. Advantage of the single engine sweepers are lower noise level, lower fuel consumption, and less maintenance cost compared to dual engine versions.

Single engine sweepers can be classified into two types.
(1) Engine drives two hydraulic pumps, one for the vehicle propulsion through a hydrostatic transmission, and the other to drive the sweeper system. U.S. Pat. No. 9,845,856 B2 discloses a typical example of this type of arrangement.
(2) Drive the vehicle using original engine and transmission and the same engine drives the hydraulic pump by means of belt drive system to power the sweeping functions.

The drawback of this arrangement is the small size of hydraulic pump that can be used for the sweeping functions. Hydraulic pump is fitted at the side of the engine in the front. Since the space available at the side of the engine is limited, smaller capacity hydraulic pump only could be mounted. As a result, sweepers could be used only for light sweeping applications due to limited hydraulic pump capacity. As the hydraulic pump is fitted in the front and very close to the engine, the hydraulic pump is exposed to hot air passing through the radiator as well as to the engine surface heat, results in higher hydraulic pump temperature. This also raises hydraulic oil temperature, and due to this hydraulic pump and allied parts life are reduced.

Where the hydraulic pump is directly coupled to the engine through drive belt arrangement, the pump will be running all the time whenever the engine is running. That means the pump will be running even during transport mode. When the sweeper is in transport mode, the hydraulic pump has no role. This results in reduced hydraulic pump life in addition to loss of energy.

Power take-off arrangements are well known in farm machinery, such as in U.S. Pat. No. 4,763,744. French patent document FR1315943 discloses a simple power take-off arrangement.

The present invention relates to single-engine sweepers and discloses improved mechanism that overcomes some of the drawbacks of the existing machines.

### SUMMARY OF THE INVENTION

An improved pump mounting mechanism (100) for a truck-mounted sweeping machine, the truck having an engine (E) with a crank shaft (S), is proposed. In various embodiments, the mechanism comprises a drive pulley (101) coupled to the engine crank shaft, the drive pulley coupled to a second driven pulley (103), a propeller shaft (105) configured to be driven by the second driven pulley, a hydraulic pump (120) placed rearward of the engine and connected to the propeller shaft to power the sweeping machine, and a clutch mechanism (125) positioned between the second pulley and the hydraulic pump wherein the clutch mechanism is configured to couple or decouple the power pack from the engine crank shaft as required.

In various embodiments the propeller shaft (105) comprises universal joints to allow for easy alignment or location of the pump. In various embodiments, the clutch mechanism (125) is an electromagnetic or a pneumatic clutch mechanism. In some embodiments the clutch mechanism is fitted at the rear end of the propeller shaft.

A truck-mounted sweeping machine with an improved pump mounting mechanism, the truck having an engine (E) with a crank shaft (S), is disclosed in various embodiments. The sweeping machine comprises a sweeper mechanism fitted with a hopper, a fan motor, gutter broom motors, broom lifting cylinders, and hopper lifting cylinders, the sweeper mechanism configured to be fitted to the rear of the truck chassis, and a power pack mounting mechanism to drive the sweeper mechanism. The power pack mounting mechanism comprises a drive pulley (101) coupled to the engine crank shaft. The drive pulley is coupled to a second driven pulley (103), and a propeller shaft (105) is configured to be driven by the second driven pulley (103). A power pack (120) placed rearward of the engine is connected to the propeller shaft, to power the sweeping machine, and is connected by a clutch mechanism (125) positioned between the second pulley and the power pack. The clutch mechanism is configured to couple or decouple the power pack from the engine crank shaft as required. The power pack is configured to provide sufficient power to drive the sweeping mechanism while the truck is in sweeping mode.

In various embodiments, the power pack may be a hydraulic pump or an electric generator.

This and other aspects are disclosed herein.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 shows a typical truck-mounted street sweeper.

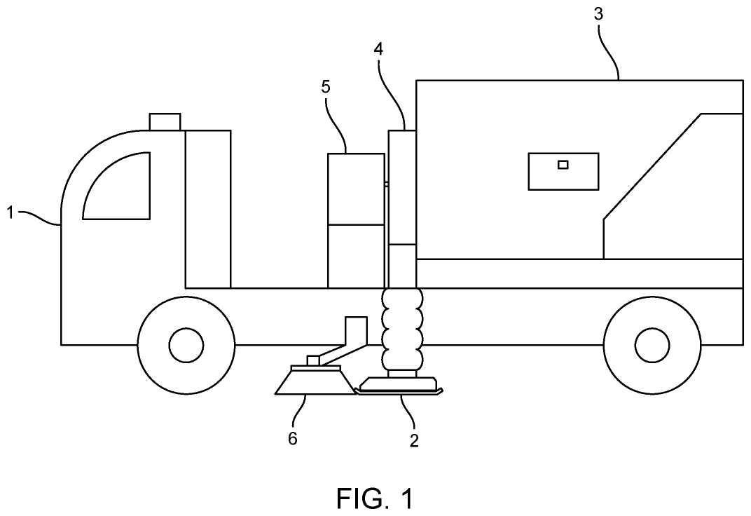

FIG. 2A illustrates a pump mounting mechanism for truck-mounted sweepers according to one embodiment of the invention.

FIG. 2B illustrates components of the pump mounting mechanism.

FIG. 2C shows right front perspective view of the mechanism shown in FIG. 2B.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

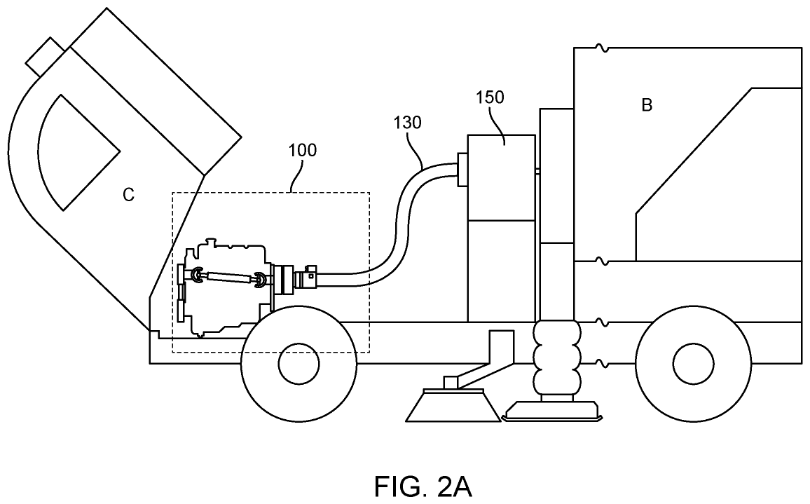

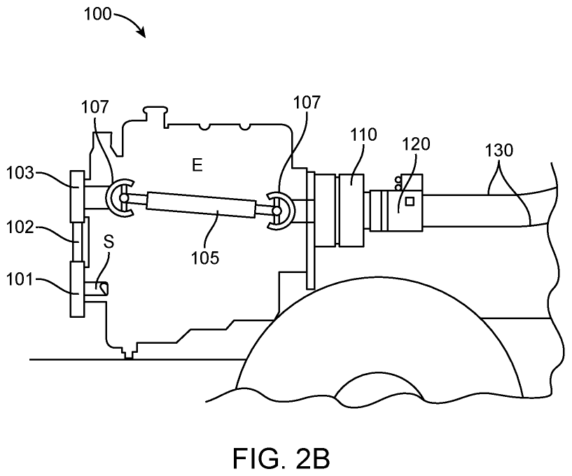

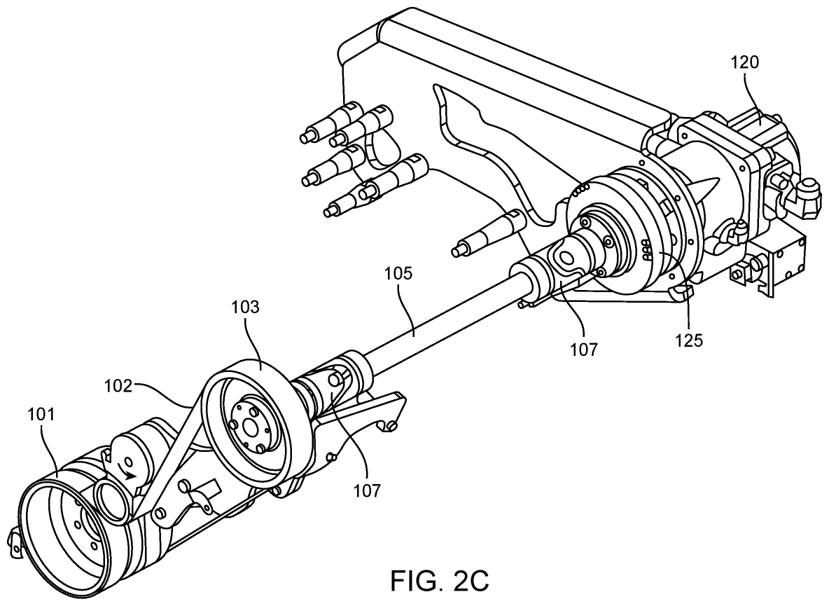

The invention in its various embodiments proposes a single-engine, truck-mounted sweeper machine that incorporates systems and devices for an improved power pack mounting mechanism 100, as illustrated with reference to FIGS. 2A, 2B, and 2C. As shown in FIG. 2A, the mechanism 100 may be located below cabin C and may be used to convey power between the engine E and sweeping mechanism 150 of the truck, via flexible lines 130. As illustrated in the side view (FIG. 2B), the mechanism 100 is configured to draw power from the engine crankshaft S and deliver the same to a power pack 120. As illustrated in this figure, the mechanism 100 includes a drive pulley 101 deriving power from the engine crank shaft S. Drive pulley 101 is coupled by a belt drive 102 to a second driven pulley 103. A propeller shaft 105 mounted at the side of the engine and extending towards the rear of the chassis is used to take power from the driven pulley 103. At the rear end of the propeller shaft the power pack 120 for driving the sweeping system is attached. The propeller shaft 105 may be mounted using suitable brackets and bearings. For further clarity, a front perspective view of the power pack mounting mechanism is shown in FIG. 2C.

Propeller shaft 105 may in various embodiments be fitted with universal joints 107 on both ends to take care of misalignments between the engine plane and the plane of the power pack. In various embodiments, the power pack 120 may be a hydraulic pump, or an electric generator, and the flexible lines 130 may correspondingly be hydraulic lines or electrical lines.

In various embodiments, a clutch 125 is introduced between the engine-driven pulley 103 and the power pack 120. The clutch 125 in various embodiments may be an electromagnetic or a pneumatic clutch, for easy actuation by the operator/driver. By this arrangement, the pump may be coupled or decoupled as required, instead of driving the hydraulic pump all the time, resulting in savings in energy by decreasing load on the engine. The clutch 125 may be fitted at the front end or at the rear end of the propeller shaft 105 as dictated by the space available. As example, fitting the clutch at the rear end is shown in FIGS. 2B and 2C.

In some embodiments of the invention, the mounting mechanism 100 may be used to drive power to energy storage devices such as a hydraulic pressure accumulator, or a battery and the like, so that the operation of the sweeper mechanism is not directly linked to speed of the engine. In some embodiments, the clutch 125 powering the power pack may be configured to automatically engage whenever hydraulic pressure within the hydraulic accumulator drops below a threshold or charge of the battery falls below a predetermined value.

In one embodiment, a truck-mounted sweeping machine with an improved power pack mounting mechanism is disclosed. The truck may have an engine (E) with a crank shaft (S), to which the power pack mounting mechanism is connected. The truck may in various embodiments, have a sweeper mechanism fitted with a hopper, a fan motor, gutter broom motors, broom lifting cylinders, and hopper lifting cylinders. The sweeper mechanism may be configured to be fitted to the rear of the truck chassis. The sweeper mechanism is configured to be powered by the power pack, as already described with reference to FIG. 2A-2C.

The embodiments described herein allow for the hydraulic pump 120 to be of sufficiently high capacity for providing effective sweeping action of the equipment. With this invention, the pump could be moved to the rear side of the engine where more space is available to mount a larger capacity hydraulic pump to drive the hydraulic motors and supply enough power to drive all sweeper elements such as fan motor, gutter broom motors, broom lifting cylinders, and hopper lifting cylinders, etc., for better sweeping performance. As the pump is moved to the rear side of the engine, the hydraulic pump is not exposed to very high engine heat. Thus, life of the hydraulic pump and related accessories and components is enhanced.

With the provision of a clutch in the power pack mounting mechanism, the pump may be coupled or decoupled as required, while the engine is running, and whether or not the vehicle is stationary or in motion. During sweeping operation, the hydraulic pump may be powered by switching ON the electric/pneumatic clutch and switched OFF during transport mode from inside the vehicle cabin. This reduces premature wear of pumps and other components, including hydraulics like seals.

The overall advantage of the invention is that higher capacity power could be provided for the sweeping function in truck-mounted sweepers, without change in engine capacity or causing environmental concerns such as emissions. The power pack mounting mechanism and system of the invention are configured to be mounted on any commercial truck chassis by mounting additional pulleys, suitable brackets and bearings on the vehicle engine to drive a hydraulic pump or an electric generator of required capacity.

While the above is a complete description of the embodiments of the invention, various alternatives, modifications, and equivalents may be used. It will be understood by those skilled in the art that various changes may be made and equivalents may be substituted without departing from the scope of the invention as described above. In addition, many modifications may be made to adapt to a particular situation or material the teachings of the invention without departing from its scope. Therefore, the above description and the examples to follow should not be taken as limiting the scope of the invention which is defined by the appended claims.

We claim:

1. An improved pump mounting mechanism for a truck-mounted sweeping machine, the truck having an engine with a crank shaft, the mechanism comprising:
a drive pulley coupled to the engine crank shaft;
the drive pulley coupled to a second driven pulley;
a propeller shaft configured to be driven by the second driven pulley;
a hydraulic pump placed rearward of the engine and connected to the propeller shaft to power the sweeping machine; and
a clutch mechanism positioned between the second pulley and the hydraulic pump wherein the clutch mechanism is configured to couple or decouple the power pack from the engine crank shaft as required.

2. The pump mounting mechanism as claimed in claim 1, wherein the propeller shaft comprises universal joints to allow for easy alignment or location of the power pack.

3. The pump mounting mechanism as claimed in claim 1, wherein the clutch mechanism is an electromagnetic or a pneumatic clutch mechanism.

4. The pump mounting mechanism as claimed in claim 1, wherein the clutch mechanism is fitted at the rear end of the propeller shaft.

5. A truck-mounted sweeping machine with an improved power pack mounting mechanism, the truck having an engine with a crank shaft, comprising:
a sweeper mechanism fitted with a hopper, a fan motor, gutter broom motors, broom lifting cylinders, and hopper lifting cylinders, the sweeper mechanism configured to be fitted to the rear of the truck chassis; and
a pump mounting mechanism to drive the sweeper mechanism, the mounting mechanism comprising:
a drive pulley coupled to the engine crank shaft;
the drive pulley coupled to a second driven pulley;
a propeller shaft configured to be driven by the second driven pulley;
a power pack placed rearward of the engine and connected to the propeller shaft, to power the sweeping machine; and
a clutch mechanism positioned between the second pulley and the power pack wherein the clutch mechanism is configured to couple or decouple the power pack from the engine crank shaft as required;
wherein the power pack is configured to provide sufficient power to drive the sweeping mechanism while the truck is in sweeping mode.

6. The truck-mounted sweeping machine as claimed in claim 5, wherein the power pack is a hydraulic pump.

7. The truck-mounted sweeping machine as claimed in claim 5, wherein the power pack is an electric generator.
